(19) United States
(12) Patent Application Publication
(10) Pub. No.: US 2017/0055777 A1
(43) Pub. Date: Mar. 2, 2017

(54) CUTTING BOARD WITH INTEGRATED DISPOSAL RECEPTACLE

(71) Applicants: Pranav Jaswant Singh, Roanoke, VA (US); Leigh Brill Singh, Roanoke, VA (US)

(72) Inventors: Pranav Jaswant Singh, Roanoke, VA (US); Leigh Brill Singh, Roanoke, VA (US)

(21) Appl. No.: 14/838,898

(22) Filed: Aug. 28, 2015

(51) Int. Cl. A47J 47/00

(52) U.S. Cl. CPC A47J 47/005

(57) ABSTRACT

A cutting board is provided. The cutting board includes a body having a substantially planar cutting surface. The body may further include a bottom which is opposite the cutting surface. The bottom may rest on a counter top. The cutting board may further include a receptacle support. The receptacle support extends from an end of the body and is angled away from the bottom. The receptacle support includes an inner edge forming an opening in between. A bag may be secured to the receptacle support so that the opening leads into the bag. The receptacle support supports the entrance of the bag in an elevated position relative to the cutting surface to catch food materials pushed towards the opening.

### BACKGROUND OF THE INVENTION

The present invention relates to cutting boards and, more particularly, to a cutting board with an integrated disposal receptacle.

Various types of processing operations are typically performed on food items prior to their cooking and/or serving. For example, food items such as vegetables, fruits, meats, fish and the like are often sliced, chopped or otherwise cut in preparation for cooking and/or serving.

Usually, cutting boards are utilized, typically in the vicinity of a sink for the cutting of food items. The conventional cutting board includes a planar surface against which food items are held while a cutting tool is hand driven in a slicing or chopping manner. The conventional cutting board is typically made of material that can withstand the cutting action of knives and the like and is generally large and heavy enough to accommodate food storage and to remain stationary while cutting pressure and motion are exerted thereon.

Although useful as a food holder and surface against which to drive a cutting tool, the conventional cutting board has certain limitations and presents some drawbacks. For example, prior art cutting boards generally do not provide means for the convenient separation of usable food portions from food scrap.

As can be seen, there is a need for an improved cutting board to separate usable food portions from food scrap.

### SUMMARY OF THE INVENTION

In one aspect of the present invention, a cutting board comprises: a body having a substantially planar cutting surface and a bottom opposite the cutting surface; and a receptacle support extending from an end of the body at an angle away from the bottom and comprising an inner edge forming an opening in between.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a side view of an embodiment of the present invention;

FIG. 4 is a top view of an embodiment of the present invention;

FIG. 5 is a bottom perspective view of an embodiment of the present invention;

FIG. 6 is an exploded view of an embodiment of the present invention;

FIG. 7 is a cutaway perspective view of the present invention along line 7-7 in FIG. 4; and

FIG. 8 is a cutaway perspective view of the present invention along line 8-8 in FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a kitchen cutting board with an integrated disposal receptacle and a cutting surface that contours to contain materials. The present invention facilitates the integration of a receptacle that is separate from the cutting surface. The cutting surface has surface contours to minimize spillage and allows for quick disposal of food scrap during the ingredient preparation process. The present invention allows for one single, convenient step to discard trash once the user is done.

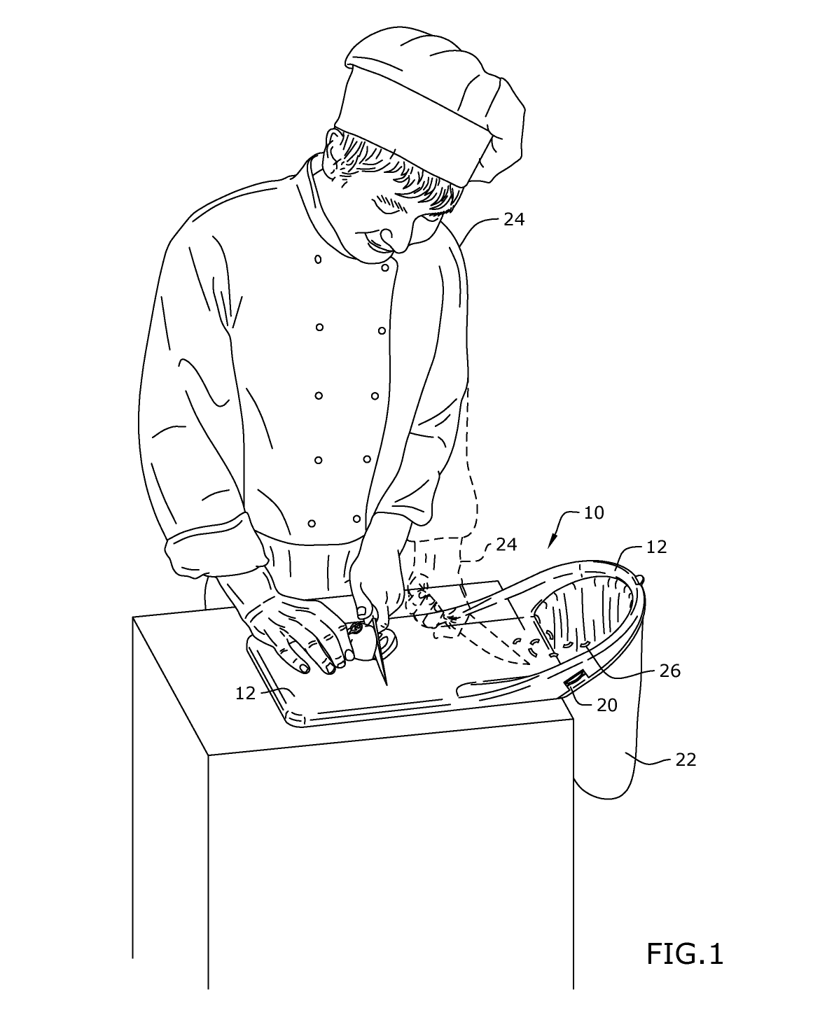

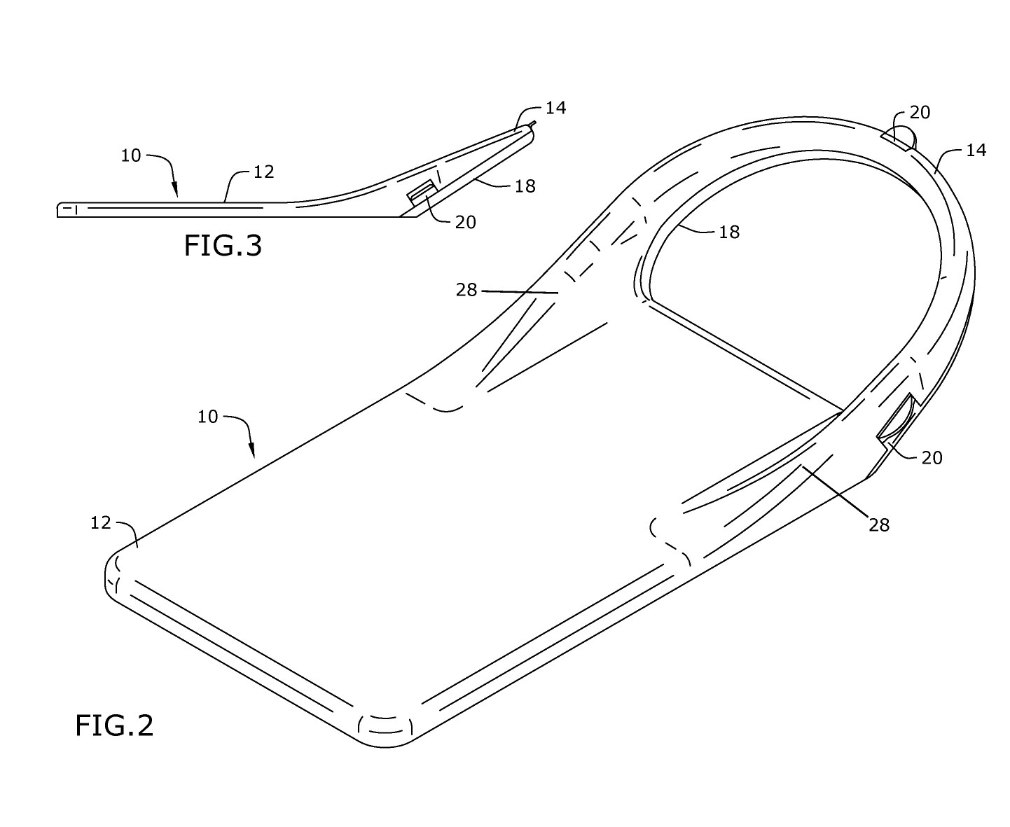

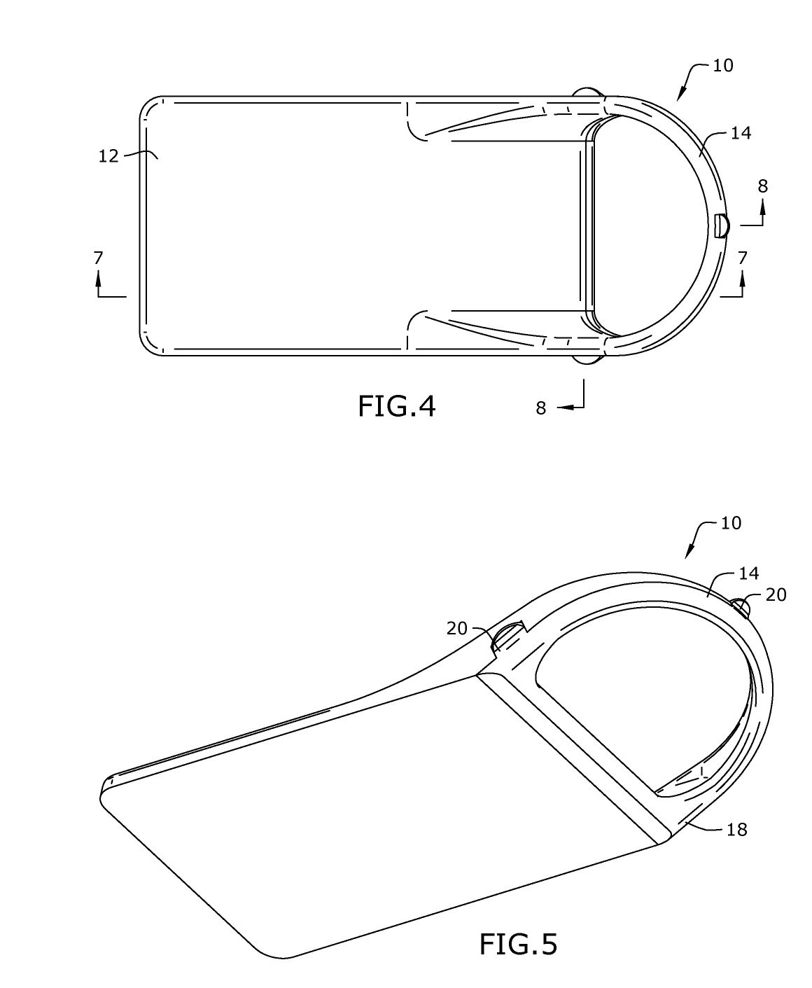

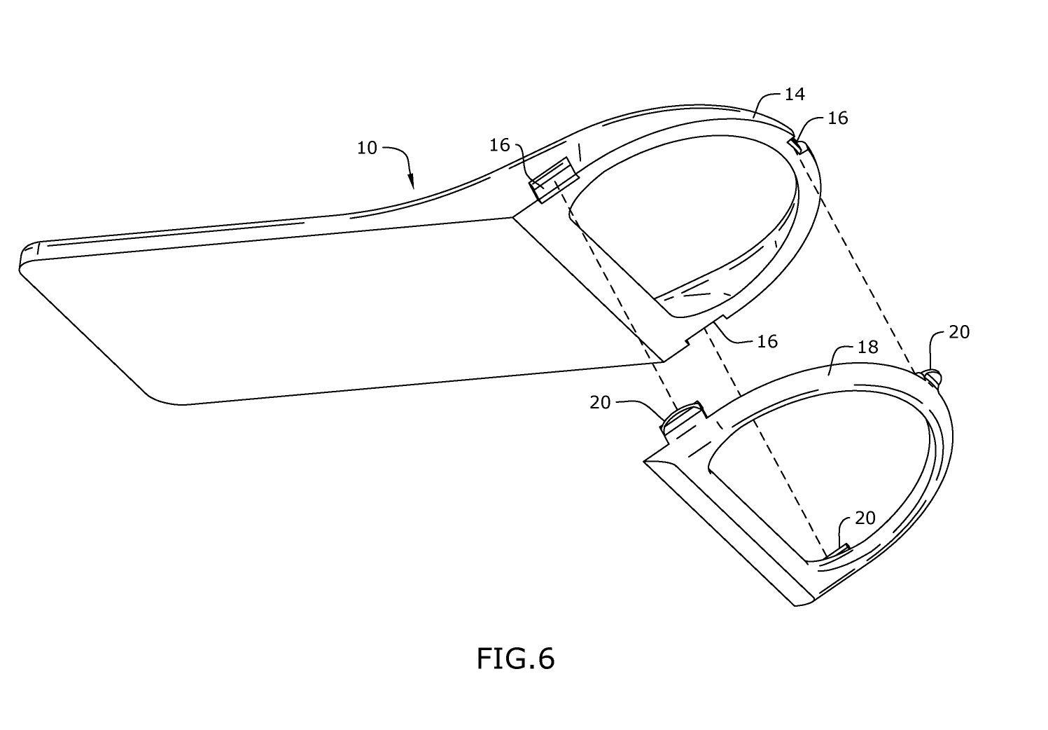

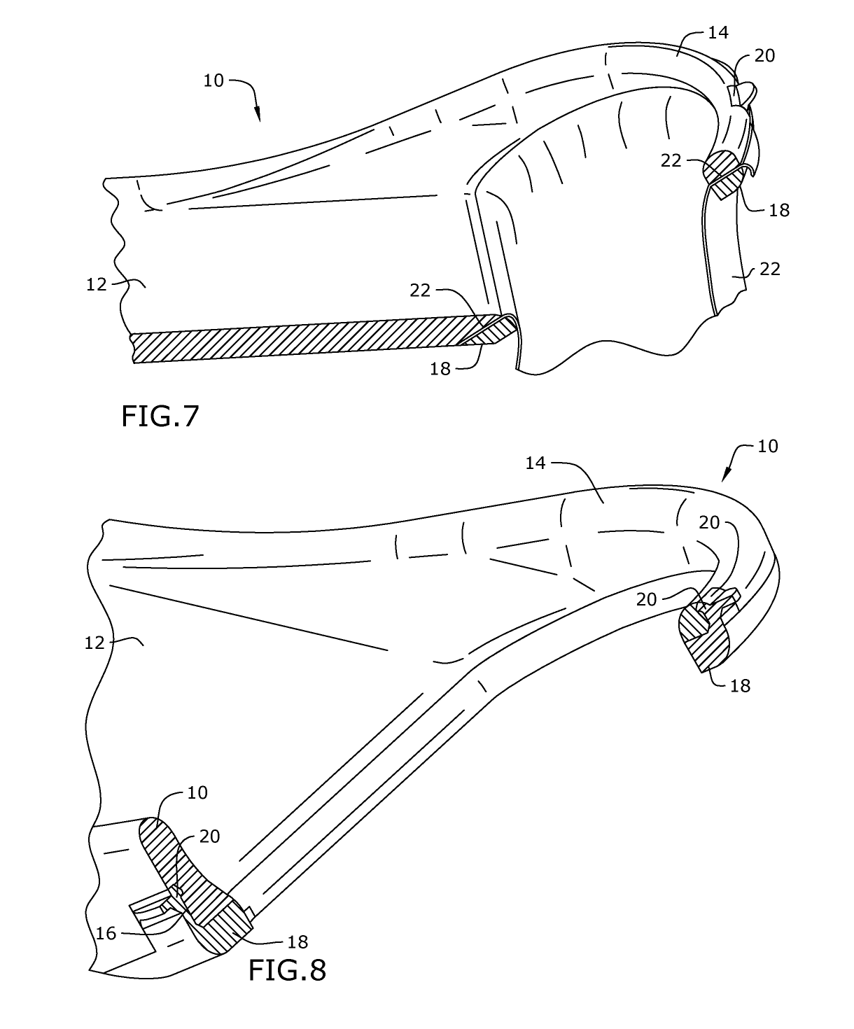

Referring to FIGS. 1 through 4, the present invention includes a cutting board 10. The cutting board 10 includes a body 12 having a substantially planar cutting surface. The body 12 may further include a bottom which is opposite the cutting surface. The bottom may rest on a counter top. The cutting board 10 may further include a receptacle support 14. The receptacle support 14 extends from an end of the body 12 and is angled away from the bottom. The receptacle support 14 includes an inner edge forming an opening in between. A bag 22 may be secured to the receptacle support 14 so that the opening leads into the bag 22. The receptacle support 14 supports the entrance of the bag 22 in an elevated position relative to the cutting surface to catch food scrap 26 pushed towards the opening.

The present invention includes a connector operable to secure the bag 22 about the periphery of the inner edge. The connector may be a clip, adhesive, clamp, latch, tie or the like. In certain embodiments, the connector may be a securement ring 18. The securement ring 18 also includes an inner edge forming an opening. The securement ring 18 is releasably attached to the receptacle support 14 so that the opening of the securement ring aligns with the opening of the receptacle support 14.

In certain embodiments, the securement ring 18 is releasably attached to an underside of the receptacle extension 14 by a latch 16, 20. The latch 16, 20 may include a spring biased clip 20 that snaps into a receiving channel 16, thereby releasably locking the securement ring 18 to the receptacle support 14. To release the securement ring 18 from the receptacle support 14, the spring biased clip 20 may be bent away from the receiving channel 16, and the securement ring 18 is released.

In certain embodiments, the present invention may include a pair of side arms 28 protruding from either side of the cutting surface. The pair of side arms 28 forms a channel in between leading into the opening formed in the receptacle support 14. The pair of side arms 28 may join the receptacle support to the body 12. In certain embodiments, the pair of side arms 28 may taper from the receptacle support 14 to the body 12 so that the side arms 28 are out of the way of the operator 24.

In use, the operator 24 may place the bottom of the cutting board on a counter top, with the receptacle support over the edge of the counter top. An upper edge of a bag 22 may be placed in between the securement ring 18 and the receptacle support 14. The spring biased clips 20 may be snapped into the receiving channel 16, securing the entire upper edge of the bag 22 in between the securement ring 19 and the receptacle support 14. The operator 24 may chop produce. The operator 24 may then push food scraps 26 through the opening and into the bag 22. Since the bag 22 is suspended below the cutting surface, over the edge of the counter top, the present invention effectively captures food scraps 26.

It should be understood, of course, that the foregoing relates to exemplary embodiments of the invention and that modifications may be made without departing from the spirit and scope of the invention as set forth in the following claims.

What is claimed is:

1. A cutting board comprising:
a body having a substantially planar cutting surface and a bottom opposite the cutting surface; and
a receptacle support extending from an end of the body at an angle away from the bottom and comprising an inner edge forming an opening in between.

2. The cutting board of claim 1, further comprising a connector operable to secure a bag about the periphery of the inner edge.

3. The cutting board of claim 2, wherein the connector comprises a securement ring comprising an inner edge forming an opening, wherein the securement ring is releasably attached to the receptacle support so that the opening of the securement ring aligns with the opening of the receptacle support.

4. The cutting board of claim 3, wherein the securement ring is releasably attached to an underside of the receptacle extension by a latch.

5. The cutting board of claim 4, wherein a bag is secured in between the securement ring and the underside of the receptacle extension.

6. The cutting board of claim 1, further comprising a pair of side arms protruding from the cutting surface forming a channel in between leading into the opening.

7. The cutting board of claim 5, wherein the pair of side arms join the receptacle support to the body.

8. The cutting board of claim 6, wherein the pair of side arms taper from the receptacle support to the body.
